(19) United States
(12) Patent Application Publication
(10) Pub. No.: US 2019/0135676 A1
(43) Pub. Date: May 9, 2019

(54) HOLLOW GLASS MICROSPHERES AND METHOD FOR PRODUCING SAME

(71) Applicant: DENNERT PORAVER GMBH, Postbauer-Heng (DE)

(72) Inventor: WOLFRAM NEIDHARDT, HILPOLTSTEIN (DE)

(21) Appl. No.: 16/181,408

(22) Filed: Nov. 6, 2018

(30) Foreign Application Priority Data
Nov. 6, 2017 (DE) 102017219693.9

(51) Int. Cl. C03B 19/10; C03C 11/00; C03C 1/02

(52) U.S. Cl. CPC C03B 19/1075; C03C 1/02; C03C 11/002

(57) ABSTRACT

Hollow glass microspheres are produced. An aqueous suspension is prepared of starting materials of finely ground glass and waterglass. Firing material particles are produced from the suspension and are mixed with a pulverulent release agent. The mixture of firing material particles and release agent is introduced into a firing chamber of a furnace where it is expanded at a firing temperature which exceeds the softening temperature of the finely ground glass, to form the hollow microspheres. The release agent is Al(OH)₃ and dehydroxylated kaolin.

### CROSS-REFERENCE TO RELATED APPLICATION

This application claims the priority, under 35 U.S.C. § 119, of German patent application DE 10 2017 219 693.9, filed Nov. 6, 2017; the prior application is herewith incorporated by reference in its entirety.

### BACKGROUND OF THE INVENTION

### Field of the Invention

The invention pertains to hollow glass microspheres and to a method for producing them.

Hollow glass microspheres, being hollow, spherical particles having typical diameters in the submillimeter range (around 1 to 1000 micrometers), are much in use as lightweight aggregates in composite materials and lightweight concrete. Other areas for use of these hollow glass microspheres (HGM) include medicine, the consumer goods industry, and the oil and gas industry. Hollow microspheres are at least substantially in a state of monocellular expansion, meaning that they have a glass wall which is thin (in comparison to the sphere diameter) and which surrounds a single large, central, and spherical cavity (with the diameter of this central cavity being only slightly less than the sphere diameter). The glass wall of a hollow microsphere of this kind may, however, include further cavities (bubbles) with a substantially smaller diameter.

HGM should be distinguished from expanded glass particles, which are likewise frequently employed as lightweight aggregates. Expanded glass particles may likewise have a spherical or spheroidal outer contour, but they differ critically from the aforementioned hollow microspheres in their multicellular structure. The volume of expanded glass particles is therefore filled by a foamlike glass matrix which surrounds a multiplicity of cavities, with each of these cavities being small in comparison to the particle size.

Expanded glass particles are customarily produced by expansion of green-particle pellets (or combustible material), formed from finely ground glass, waterglass, and an expandant, in a rotary tube furnace. To prevent the fused firing material particles sticking to the furnace wall or to other firing material particles, a release agent is generally introduced into the furnace together with the combustible material. Examples of release agents used include kaolin and finely ground clay.

Hollow glass microspheres and expanded glass particles may in principle be produced from the same or similar starting materials. From a process engineering standpoint, however, the production of hollow glass microspheres is substantially more difficult to manage than the production of expanded glass particles. This is so in particular because, in order to produce hollow microspheres, the green particles have to be melted to a much greater degree than for expanded glass production, so that the bubbles which form at the start of the expansion process unite to form the large central cavity and are therefore able to displace the glass matrix to the outer margin of the sphere.

With the greater melting of the glass matrix, however, there is a considerable increase in the propensity of the particles to stick. Moreover, the risk increases for the melted particles to be crushed or abraded away by contact with other particles or with the furnace wall during the expansion process. To date, therefore, it has generally not been possible, or at least not on an industrial scale, to use rotary tube furnaces in order to produce hollow glass microspheres, despite the fact that the use of rotary tube furnaces would in and of itself be advantageous, on account of their robustness, the high achievable throughput, and the comparatively low cost and effort of their operation. In particular, the tendency of the particles to stick cannot usually be adequately managed by using the conventional release agents.

To date, therefore, hollow glass microspheres have customarily been produced in vertical furnaces (also referred to below as “shaft furnaces”), in which either the green particles are expanded in an upwardly directed flow of hot gas, and then discharged with the gas flow from the upper end of the vertical furnace (in accordance, for example, with U.S. Pat. No. 3,230,064), or the green particles are expanded in falling (in accordance, for example, with United States Patent Publication US 2007/0275335 A1).

### BRIEF SUMMARY OF THE INVENTION

It is accordingly an object of the invention to provide improved hollow glass microspheres and an improved method of producing hollow glass microspheres which overcomes the above-mentioned and other disadvantages of the heretofore-known devices and methods of this general type and which enables an effective production of hollow glass microspheres.

With the foregoing and other objects in view there is provided, in accordance with the invention, a method of producing hollow glass microspheres, the method comprising:

preparing an aqueous suspension of starting materials of finely ground glass and waterglass;

producing firing material particles from the suspension;

forming a mixture by mixing the firing material particles with a pulverulent release agent containing Al(OH)₃ and dehydroxylated kaolin;

introducing the mixture of firing material particles and release agent into a firing chamber of a furnace; and

expanding the firing material particles in the firing chamber at a firing temperature which exceeds a softening temperature of the finely ground glass, to form the hollow microspheres.

According to the method, for the production of hollow glass microspheres, an aqueous suspension is prepared of starting materials comprising finely ground glass and waterglass, this suspension being referred to below as “starting suspension”. The starting suspension is optionally admixed with an expandant (also referred to as “blowing agent”; e.g., soda niter, glycerol or sugar). From the starting suspension, firing material particles (“green particles”) are produced, with diameters of preferably between 1 micrometer and 700 micrometers, more particularly between 20 micrometers and 200 micrometers. The lower limit of the above range figures refers here, for example, to the d₁₀ of the respective particle size distribution. The upper limit refers, for example, to the d₉₀ of the respective particle size distribution. The “dₓ” (where x=10, 50, 90, etc.) of the particle size indication, here and hereinafter, means that x% of the particles have a size of not more than dᵣ. For example, then, the d₅₀ indicates the mean particle size in respect of which 50% of the particles are smaller. The firing material particles are mixed with a pulverulent release agent, after which the mixture of firing material particles and release agent is introduced into a firing chamber of a furnace.

In the firing chamber, where the prevailing firing temperature exceeds the softening temperature of the finely ground glass, the firing material particles, finally, undergo expansion to form the hollow microspheres. Here, in a typical manifestation of the method, the firing material particles undergo an increase in their diameter, or expansion, of 25% to 70%. In total, the diameter of the hollow microspheres resulting from the expansion process, in typical sizing, is between around 2 and 1000 micrometers, preferably between 7 micrometers and 600 micrometers.

Employed in accordance with the invention is a release agent which comprises aluminum hydroxide, i.e., Al(OH)₃, and dehydroxylated kaolin. The term “dehydroxylated kaolin” is used as a generic term, embracing metakaolin and calcined (anhydrous) kaolin. Metakaolin is customarily produced by heating kaolin to temperatures between 650° C. and 750° C. Calcined (anhydrous) kaolin is obtained by heating kaolin to temperatures above 900° C.—see, for example, EP1 715 009 A2.

The invention is based on extensive experiments which have shown that the use of Al(OH)₃ as a release agent effectively suppresses the tendency of the green grain particles, and also of the resultant hollow microspheres, to stick, hence allowing the hollow microspheres to be produced at least in a small, indirectly heated rotary tube furnace (pilot scale). It has emerged, however, that when using pure Al(OH)₃ as release agent, the process is difficult and ultimately unsatisfactory to scale up to the industrial scale (production scale). When industrial rotary tube furnaces, especially directed heated rotary tube furnaces, were utilized on the production scale, it was not possible experimentally to achieve satisfactory suppression of the agglomeration of the grain particles and of the resultant hollow microspheres, and so product of unsatisfactory quality was observed or premature interruption to production was needed in order for the furnaces to be cleaned. As a result of this, in further experiments with modified release agent compositions, it was found that the mixing of Al(OH)₃ with dehydroxylated kaolin allows the production of release agents having an improved release effect by comparison with pure Al(OH)₃, thereby critically increasing the efficiency of the process, including and especially when using an industrial rotary tube furnace.

In advantageous embodiments of the mixed release agent, the fractions of Al(OH)₃ and dehydroxylated kaolin are preferably selected such that,

the fraction of Al(OH)₃ in the mixture of firing material particles and release agent is between 7 wt % and 30 wt %, preferably between 10 wt % and 25 wt %, and

the fraction of dehydroxylated kaolin in the mixture of firing material particles and release agent is between 2 wt % and 15 wt %, preferably between 5 wt % and 10 wt %.

The release agent preferably consists exclusively of Al(OH)₃ and dehydroxylated kaolin, apart from customary impurities in the order of magnitude of at most 1 to 2 wt %.

In a useful development of the invention, the Al(OH)₃ used optionally for the release agent is selected or conditioned in such a way that at least 90% of the Al(OH)₃ particles in the release agent have a particle diameter of less than 4 micrometers (d₉₀=4 μm), preferably less than 3.5 micrometers (d₉₀=3.5 μm).

In a useful development of the invention, the dehydroxylated kaolin used optionally for the release agent is selected or conditioned in such a way that at least 90% of the dehydroxylated kaolin particles in the release agent have a particle diameter of less than 5 micrometers, preferably less than 4 micrometers. Having been found experimentally to be particularly suitable, and therefore also preferred, in this case are products in which the dehydroxylated kaolin particles have a mean particle size of 3 μm.

The firing material particles are produced preferably by spray granulation. Alternatively, the firing material particles are produced by granulation in an intensive mixer, more particularly in an Eirich intensive mixer.

In one useful embodiment of the method, the firing material particles, before being fed to the firing chamber, are mixed with the pulverulent release agent in an intensive mixer. This mixing in the intensive mixer produces a particularly dense and homogeneous distribution of the release agent on the surface of the firing material particles, and therefore—in comparison to other kinds of mixing of firing material particles and release agent—allows a saving to be made in release agent, without any need to accept an increase in agglomeration during the firing process.

An intensive mixer is a mixer in which the mixing procedure is carried out at a power input of at least about 2 kilowatts per 100 kilograms of mixture, or one whose mixing tool in the mixing procedure moves at a peripheral velocity of at least 15 meters per second relative to the mixing vessel. The intensive mixer used in accordance with the invention preferably features a power input of at least 5 kilowatts per 100 kilograms of mixture, more particularly at least 10 kilowatts per 100 kilograms. One preferred embodiment uses an Eirich intensive mixer to mix the firing material particles with the release agent. Within the context of the invention, however, it is also possible in principle to carry out the method using a “horizontal” Lödige plowshare mixer or with an Ekato mixer, which is characterized by a conical mixing vessel. Before being introduced into the firing chamber, the mix of firing material particles and release agent is preferably mixed intensively for a mixing time of 1 to 10 minutes, more particularly for around 5 minutes.

The furnace employed for the expansion process is preferably a rotary tube furnace. Employed more particularly here is a rotary tube furnace which is heated directly (that is, from the inside) by flaming, and which, on account of its rational mode of operation and of the high firing temperatures (which are comparatively easy to attain) is advantageous for the production of hollow glass microspheres. A decisive step forward here is that with the method of the invention it is possible to utilize the advantages of the directly heated rotary tube furnace without any overheating of the firing material particles and of the hollow microspheres formed from them. An alternative to this is to use a rotary tube furnace heated indirectly (again, preferably, by flaming). In the latter case, the supply of heat into the firing chamber is accomplished from outside via the outer surface of the rotary tube. A further alternative within the method of the invention is to use a shaft furnace (vertical furnace), in which the firing material particles are expanded in an ascending stream of hot gas. In this variant method as well, the use of the release agent of the invention has been found to result in a substantial reduction in the sticking tendency, and to make an advantageous contribution to the formation of the hollow spheres.

The firing process is carried out preferably at a firing temperature of between 800° C. and 980° C., preferably between 830° C. and 940° C.

One special embodiment of the invention are the hollow glass microspheres obtainable by the above-described method of the invention.

Another embodiment of the invention is the use of a release agent which comprises Al(OH)₃ in a mixture with dehydroxylated kaolin (in particular, metakaolin or calcined (anhydrous) kaolin), in the production of hollow glass microspheres.

Other features which are considered as characteristic for the invention are set forth in the appended claims.

Although the invention is illustrated and described herein as embodied in hollow glass microspheres and a method for producing same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a greatly simplified schematic illustration of a plant for producing hollow glass microspheres according to the invention; and

FIG. 2 in a representation in accordance with FIG. 1, shows an alternative embodiment of the plant, in which the combustion furnace is implemented as a shaft furnace.

### DETAILED DESCRIPTION OF THE INVENTION

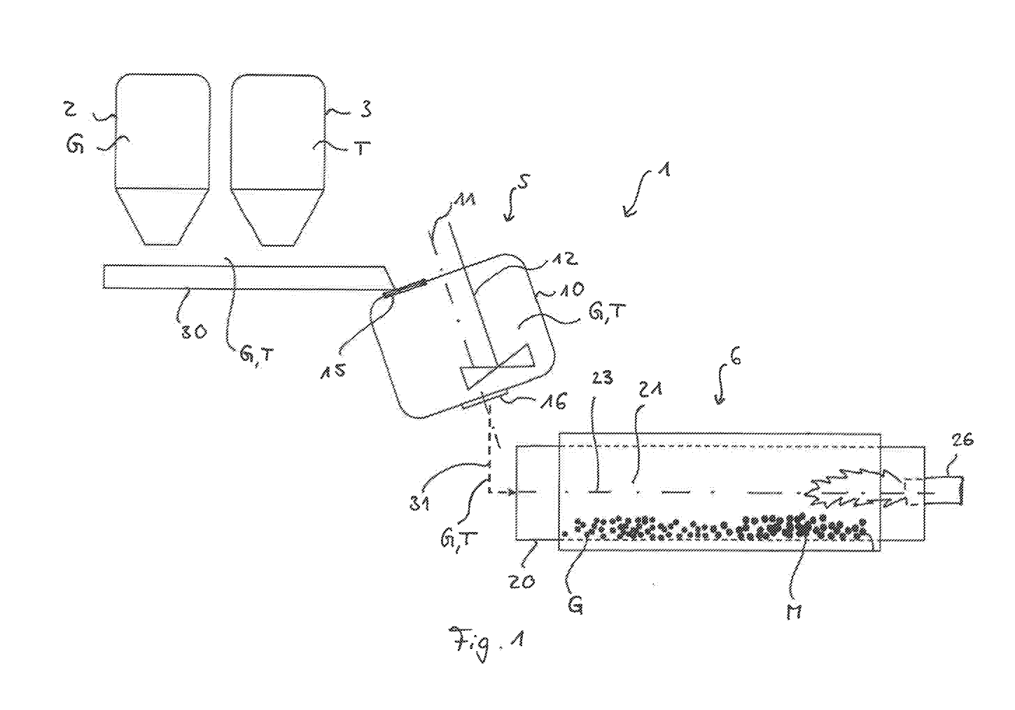

Referring now to the figures of the drawing in detail and first, particularly, to FIG. 1 thereof, there is shown a plant for producing hollow glass microspheres, having a mixer for mixing firing material particles with a pulverulent release agent composed of Al(OH)₃ in a mixture with dehydroxylated kaolin, and also having a combustion furnace, implemented as a rotary tube furnace, into which the mixture of firing material particles and release agent is introduced, so that the firing material particles are expanded to form the desired hollow microspheres

FIG. 1 shows a plant 1 for producing hollow glass microspheres M, i.e., for producing hollow glass spheres whose typical diameters are predominantly, for example, in a range of between 40 and 350 micrometers.

The plant 1 comprises a first silo 2, which forms a reservoir vessel for firing material particles G, and also a second silo 3, which forms a reservoir vessel for pulverulent release agent T. Additionally, the plant 1 comprises a mixer 5 for mixing the firing material particles G with the release agent T, and also a combustion furnace, implemented as a rotary tube furnace 6, for expanding the combustion particles G to form the desired hollow microspheres M.

The firing material particles G stored in the first silo 2 are approximately spherical particles whose diameters are, preferably, approximately in the range between 20 micrometers and 200 micrometers (μm). The firing material particles G are produced preferably by spray granulation. Starting materials for that process, comprising finely ground glass, waterglass, and an expander (e.g., soda niter, sugar, or glycerol), are used to prepare a highly mobile suspension (slip) with water, and this suspension is sprayed in a spraying tower in order to form the firing material particles G. The firing material particles G are subsequently dried. Drying is followed optionally by classifying, where the fraction having the desired diameters is selected and supplied to the silo 2.

In the embodiment of the plant 1 that is shown, the mixer 5 is implemented as an Eirich intensive mixer. The mixer 5 in this case comprises a substantially cup-shaped mixing vessel 10, which is mounted rotatably about its longitudinal axis 11, which is inclined relative to the vertical. A mixing tool 12, which is rotatable counter to the mixing vessel 10, is arranged eccentrically in the mixing vessel 10, in parallel to the longitudinal axis 11. The mixing vessel 10 can be charged by way of a closable lid opening 15 and can be emptied via a likewise closable and centrally disposed base opening 16. In exemplary sizing, the mixer 5 in this embodiment has a power input of 10 to 20 kilowatts per 100 kg mixture (preferably about 15 kilowatts per 100 kg mixture) and a peripheral velocity at the outermost point of the stirring tool of at least 30 meters per second. In alternative embodiments, however, the plant 1 may also include a different kind of mixer, such as a drum mixer, for example.

The rotary tube furnace 6 conventionally comprises an elongated, hollow-cylindrical rotary tube 20 made from steel which is resistant to high temperatures, with a firing chamber 21 formed in the interior of the tube. The rotary tube 20 is mounted rotatably about its longitudinal axis 23, which is arranged with a slight incline relative to the horizontal. As shown, the rotary tube furnace is designed as a directly heated rotary tube furnace. The firing chamber 21 in this case is fired directly with a gas-operated burner 26, which is disposed at the output end of the rotary tube 20.

In the operation of the plant 1, firing material particles G and release agent T are metered from the two silos 2, 3 onto a mixing chute 30 which is disposed beneath the silos 2, 3, so that at that point there is a premix composed of firing material particles G and release agent T, with a specified release agent fraction. The desired mass ratio is set by means of a balance, for example. Alternatively, the setting is performed volumetrically, by means of conveying screws or star wheels assigned to the silos 2, 3, for example. Via the mixing chute 30, the premix of firing material particles G and release agent T is conveyed into the mixing vessel 10 of the mixer 5.

Alternatively to the exemplary representation, there may also be no mixing chute 30, in which case firing material particles G and release agent T are each metered separately into the mixer 5, so that the desired mixing ratio is generated there.

The mixing procedure takes place batchwise, with one batch of the premix being subjected to a mixing procedure in each case. The premix of release agent T and firing material particles G is homogenized in the mixer 5 for a mixing time of 1 to 10 minutes. After the end of the mixing procedure, the mixture of firing material particles G and release agent T is discharged from the mixing vessel 10 via the base opening 16. The mixture is optionally stored in a buffer vessel (not shown explicitly) which is placed between the mixer 5 and the rotary tube furnace 6.

From the mixing chute 30 or the optional downstream buffer vessel, the mixture of firing material particles G and release agent T is supplied continuously, by means of a charging facility which is not shown explicitly here, to the firing chamber 21 of the rotary tube furnace 6 (indicated by an arrow 31). In the firing chamber 21, in the operation of the plant 1, the burner 26 is used to generate a specified firing temperature, at which the firing material particles G undergo successive expansion to form the desired hollow microspheres M within a period of around 1 to 15 minutes.

The hollow microspheres M produced are discharged from the firing chamber 21 and, after a cooling and sorting step, are supplied to a product reservoir (not shown here). The release agent T is separated from the hollow microspheres M by sieving or pneumatic classifying. Optionally, again by sieving or pneumatic classifying, the hollow microspheres M are separated from particles which have undergo multicellular (foamlike) expansion (that is, particles having a plurality of large cavities), which may be formed during the firing process alongside the hollow microspheres M. These multicellularly expanded particles are either discarded as rejects or supplied for an alternative use.

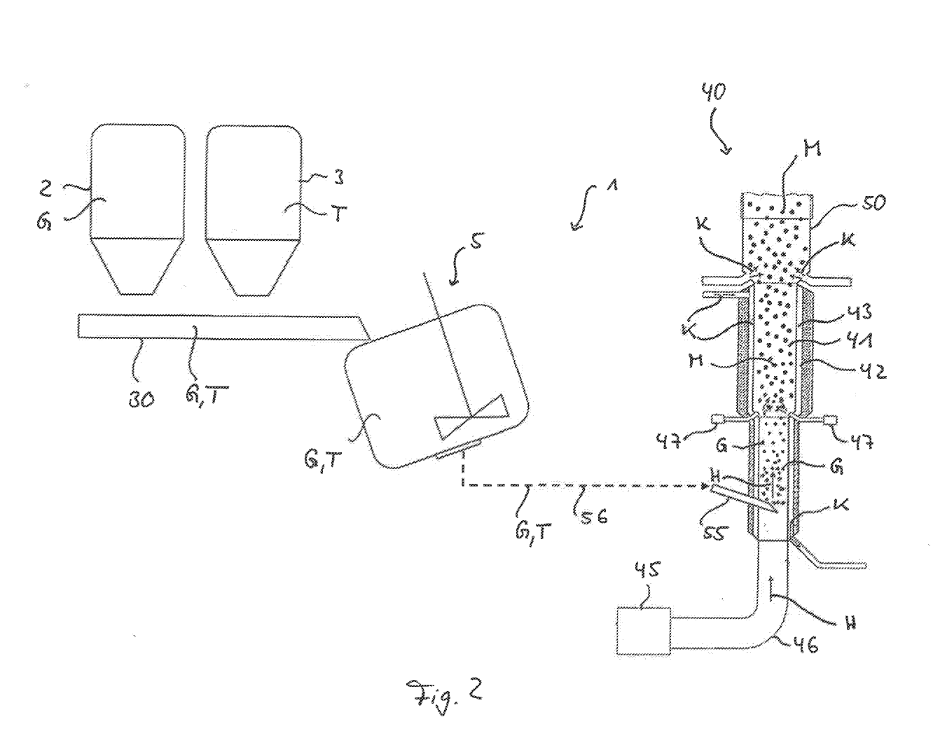

FIG. 2 shows an alternative embodiment of the plant 1. In contrast to the first embodiment, the expansion process here is carried out not in a rotary tube furnace but instead in a shaft furnace 40.

The shaft furnace 40 comprises a firing chamber 41 which is extended in the manner of a shaft and aligned vertically with respect to the longitudinal extent, this chamber 41 being surrounded by a double jacket 42 of steel that is insulated thermally with respect to the outside. Cooling air K is guided in a cooling gap 43 which is formed by the double jacket 42. Toward the top, the firing chamber 41 is widened in a steplike manner.

Assigned to the shaft furnace 40 is a gas-operated burner 45, which is used to generate a hot gas stream H, within the firing chamber 41, that is directed from bottom to top. For this purpose, the hot gas generated by the burner 45 is supplied via a hot gas line 46 to the firing chamber 41 as hot gas stream H. At approximately half the height of the firing chamber 41, specifically in the region of the above-described cross-sectional widening, there are a number (six, for example) of additional gas-operated burners 47, which are positioned in a crownlike distribution around the periphery of the firing chamber 41.

Adjoining the firing chamber 41 at the top, according to FIG. 2, is a region which serves as a cold trap 50 and which has a cross section widened further relative to the cross section of the upper portion of the firing chamber 41. Alternatively, the firing chamber 41 and also the optional cold trap 50 may be implemented with a uniform cross section over the whole of their height.

The shaft furnace 40, finally, comprises a charging facility, formed in this case by a combustibles line 55. The combustibles line 55 is passed through the double jacket 42 and opens into the lower portion of the firing chamber 41. The combustibles line 55 is fed from the mixer 5 or from an optionally downstream buffer vessel (indicated by the arrow 56). The combustibles line 55 runs in particular with a descent in the charging direction, so that without active conveying (merely under the action of gravity) the combustible material slides into the firing chamber 41. Optionally, however, the charging facility may also comprise means for the active conveying of the combustible material—for example, a compressed air system or a conveying screw.

In the operation of the plant 1, in the exemplary embodiment above, the homogeneous mixture of firing material particles G and release agent T is conveyed continuously by means of the combustibles line 55 into the firing chamber 41, where it is captured by the hot gas stream H and carried upward.

In the lower portion of the firing chamber 41, a temperature is generated of around 650° C., for example, at which the firing material particles G are first of all preheated. The firing chamber 41 is additionally heated by the burners 47, and so the temperature in the upper portion of the firing chamber 41 is increased to the firing temperature which exceeds the softening temperature of the finely ground glass. The expansion of the firing material particles G to form the hollow microspheres M takes place here in brief flame contact at approximately 1400° C.

The expanded hollow microspheres M are supplied, finally, to the cold trap 50, where they are quenched by supply of cooling air K. Finally, the hollow microspheres M are isolated from the hot gas stream via a solids separator, and, optionally after a sorting step, they are supplied to a product reservoir (again not shown here). The entrained release agent T is separated in turn from the hollow microspheres M by means of a cyclone.

### EXAMPLE 1 (INVENTION)

91 wt % of finely ground used glass (d₉₇≈50 μm), 7 wt % of sodium silicate and 2 wt % of soda niter were admixed with water to produce a highly mobile slip, which was subsequently granulated in a spraying tower. For the present example, the fine particle fraction of the sprayed granules was employed, this fraction being discharged from the spraying tower with the air stream and deposited in a downstream cyclone. The firing material particles thus obtained have a particle size distribution of d₁₀≈30 μm, d₅₀≈80 μm and d₉₀≈175 μm.

The dried firing material particles were mixed for five minutes in an Eirich intensive mixer with the release agent, composed of Al(OH)₃ (particle size distribution: d₁₀=0.6 μm; d₅₀=1.3 μm; d₉₀=3.2 μm; purity: 99.5% and metakaolin (particle size distribution: d₁₀=1 μm; d₅₀=2 μm; d₉₀=10 μm) in the following proportions:

70 wt % firing material particles

30 wt % release agent (20 wt % Al(OH)₃ and 10 wt % metakaolin)

This mixture was subsequently expanded in a directly heated rotary tube furnace (production scale). In this and all the experiments described below, the firing temperature was varied during the progress of the experiment, until hollow microspheres were produced (at the firing temperatures stated; in the case of inventive example 1, at a firing temperature of 816° C.).

This experiment produced hollow microspheres with good product quality in the fractions having sphere diameters in the 40-90 μm and 90-180 μm ranges. Hollow microspheres of the fraction having sphere diameters in the 180-300 μm range, however, were not fully foamed. No agglomeration was observed.

### EXAMPLE 2 (INVENTION)

The firing material particles produced in the same way as for inventive example 1 were again mixed for five minutes in an Eirich mixer with the release agent, which again consisted of Al(OH)₃ (as in inventive example 1) and metakaolin (as in inventive example 1) in the following proportions:

70 wt % firing material particles

30 wt % release agent (25 wt % Al(OH)₃ and 5 wt % metakaolin)

This mixture was subsequently expanded in a directly heated rotary tube furnace (production scale) at a firing temperature of 780-840° C.

In this experiment, hollow microspheres with good product quality were obtainable in the fractions having sphere diameters in the 40-90 μm, 90-180 μm, and 180-300 μm ranges. No agglomeration was observed.

### EXAMPLE 3 (INVENTION)

The firing material particles produced in the same way as for inventive example 1 were again mixed for five minutes in an Eirich mixer with the release agent, which again consisted of Al(OH)₃ (as in inventive example 1) and metakaolin (as in inventive example 1) in the following proportions:

70 wt % firing material particles

30 wt % release agent (10 wt % Al(OH)₃ and 20 wt % metakaolin)

This mixture was subsequently expanded in a directly heated rotary tube furnace (production scale) at a firing temperature of 814° C.

In this experiment, hollow microspheres with good product quality were obtainable in the fractions having sphere diameters in the 40-90 μm and 90-180 μm ranges. Hollow microspheres of the fraction having sphere diameters in the 180-300 μm range, however, were not fully foamed. Moreover, agglomeration was observed.

### EXAMPLE 4 (INVENTION)

The firing material particles produced in the same way as for inventive example 1 were again mixed for five minutes in an Eirich mixer with the release agent, which again consisted of Al(OH)₃ (as in inventive example 1) and calcined kaolin (d₁₀=1 μm; d₅₀=2 μm; d₉₀=10 μm) in the following proportions:

70 wt % firing material particles

30 wt % release agent (25 wt % Al(OH)₃ and 5 wt % calcined kaolin)

This mixture was subsequently expanded in a directly heated rotary tube furnace (production scale) at a firing temperature of 838° C.

In this experiment, hollow microspheres with good product quality were obtainable in the fractions having sphere diameters in the 40-90 μm, 90-180 μm, and 180-300 μm ranges. However, agglomeration was observed.

### COMPARATIVE EXAMPLE 1

The firing material particles produced in the same way as for inventive Example 1 were here mixed for 5 minutes in the Eirich mixer with the release agent, which here consisted only of Al(OH)₃ (as in Example 1), in the following proportions:

75 wt % firing material particles

25 wt % release agent (Al(OH)₃)

In the same way as for inventive example 1, this mixture was expanded in the directly heated rotary tube furnace (production scale) at a firing temperature of 720° C.

In this experiment it was not possible to obtain any satisfactory product quality. Besides hollow microspheres, the expanded material included a high fraction of rejects (particles having undergone multicell expansion).

### COMPARATIVE EXAMPLE 2

The firing material particles produced in the same way as for inventive example 1 were mixed here for 5 minutes in the Eirich mixer with the release agent, which here likewise consisted only of Al(OH)₃ (as in inventive example 1), in the following proportions:

76 wt % firing material particles

24 wt % release agent (Al(OH)₃)

In the same way as for inventive example 1, this mixture was expanded in the directly heated rotary tube furnace (production scale) at a firing temperature of 800° C.

In this experiment, it was not possible to maintain stable production of hollow microspheres. After initial production of high-quality hollow microspheres, there were increasingly agglomerates and reject particles (particles having undergone multicell expansion).

### COMPARATIVE EXAMPLE 3

The firing material particles produced in the same way as for inventive example 1 were mixed here for 5 minutes in the Eirich mixer with the release agent, which here consisted of metakaolin, in the following proportions:

75 wt % firing material particles

25 wt % release agent (metakaolin)

In the same way as for inventive example 3, this mixture was expanded in the directly heated rotary tube furnace (production scale) at a firing temperature of 862° C. to 930° C.

The product resulting from this experiment consisted almost exclusively of particles having undergone multicellular expansion. No agglomerates were observed.

The following is a summary list of reference numerals and the corresponding structure used in the above description of the invention:

1 plant

2 silo

3 silo

5 mixer

6 rotary tube furnace

10 mixing vessel

11 longitudinal axis

12 mixing tool

15 lid opening

16 base opening

20 rotary tube

21 firing chamber

23 longitudinal axis

25 cladding

26 burner

30 mixing chute

31 arrow

40 shaft furnace

41 firing chamber

42 jacket

43 cooling gap

45 burner

46 hot gas line

47 burner

50 cold trap

55 combustibles line

56 arrow

60 cavity

61 glass wall

62 (outer) layer

63 aluminum oxide particles

64 (inner) region

G firing material particles

H hot gas stream

K cooling air

M hollow microspheres

T release agent

1. A method of producing hollow glass microspheres, the method comprising:
preparing an aqueous suspension of starting materials of finely ground glass and waterglass;
producing firing material particles from the suspension;
forming a mixture by mixing the firing material particles with a pulverulent release agent containing Al(OH)₃ and dehydroxylated kaolin;
introducing the mixture of firing material particles and release agent into a firing chamber of a furnace; and
expanding the firing material particles in the firing chamber at a firing temperature which exceeds a softening temperature of the finely ground glass, to form the hollow microspheres.

2. The method according to claim 1, wherein:
a fraction of Al(OH)₃ in the mixture of firing material particles and release agent is between 7 wt % and 30 wt %; and
a fraction of dehydroxylated kaolin in the mixture of firing material particles and release agent is between 2 wt % and 15 wt %.

3. The method according to claim 2, wherein:
the fraction of Al(OH)₃ in the mixture is between 10 wt % and 25 wt %; and
the fraction of dehydroxylated kaolin in the mixture is between 5 wt % and 10 wt %.

4. The method according to claim 1, wherein at least 90% of the Al(OH)₃ particles in the release agent have a particle diameter of less than 4 micrometers.

5. The method according to claim 4, wherein at least 90% of the Al(OH)₃ particles in the release agent have a particle diameter of less than 3.5 micrometers.

6. The method according to claim 1, wherein at least 90% of the dehydroxylated kaolin particles in the release agent have a particle diameter of less than 5 micrometers.

7. The method according to claim 6, wherein at least 90% of the dehydroxylated kaolin particles in the release agent have a particle diameter of less than 4 micrometers.

8. The method according to claim 1, which comprises mixing the firing material particles with the pulverulent release agent in an intensive mixer.

9. The method according to claim 1, wherein the furnace is a rotary tube furnace.

10. The method according to claim 9, wherein the furnace is a directly heated rotary tube furnace.

11. The method according to claim 1, which comprises setting the firing temperature to a value between 800° C. and 980° C.

12. The method according to claim 11, which comprises setting the firing temperature to a value between 830° C. and 940° C.

13. A multiplicity of hollow glass microspheres, each microsphere comprising a glass wall surrounding a central cavity and having been obtained by the method according to claim 1.

14. A release agent, comprising Al(OH)₃ and dehydroxylated kaolin in pulverulent form, wherein the Al(OH)₃ and the dehydroxylated kaolin, in a mixture with firing material particles formed from an aqueous suspension of starting materials of finely ground glass and waterglass act as a release agent in the production of hollow microspheres.
